(19) United States
(12) Patent Application Publication
(10) Pub. No.: US 2015/0226535 A1
(43) Pub. Date: Aug. 13, 2015

(54) Gauge Connector

(71) Applicant: Craig V. Winborn, Odessa, TX (US)

(72) Inventor: Craig V. Winborn, Odessa, TX (US)

(21) Appl. No.: 14/178,030

(22) Filed: Feb. 11, 2014

(51) Int. Cl. G01B 5/00

(52) U.S. Cl. CPC G01B 5/0002

(57) ABSTRACT

A gauge connector for connecting a gauge device to a container that holds liquids is disclosed herein. The disclosed gauge connector generally comprises a body formed by a cylindrical wall surrounding a fluid passageway, wherein the body has a first end including a front wall that seals off the fluid passageway and a second end that is an open end that fluidly connects the body with the container. The gauge connector further comprises a first shoulder connected to the cylindrical wall of the body, a second shoulder connected to the cylindrical wall of the body, a first arm connected to the first shoulder, and a second arm connected to the second shoulder. The first arm and the second arm are arranged and configured to connect the disclosed gauge connector to a gauge device.

### BACKGROUND OF THE INVENTION

1. Field of the Invention

The present invention generally relates to a gauge connector and method of use. More specifically, the present invention relates to a device for connecting a gauge to a chemical tank, drum, or the like.

2. Description of Related Art

Hydraulic fracturing (“fracking”) is widely used in the petroleum industry to enhance recovery of oil and natural gas. Chemicals used in fracking are initially stored in chemical tanks or the like before the chemicals are mixed with a fracking fluid and then injected into a wellbore. Using a chemical injection pump system, the chemicals are injected into the fracking fluid at a selected rate.

Gauges are measuring instruments that may be used to measure the level or amount of a chemical in a tank and/or to measure the pumping rate of a chemical injection pump. Such gauges include liquid level gauges, level indicators, pump setting gauges, drum gauges, etc. These gauge devices are often used in the petroleum and chemical industries for measuring the level of a chemical or other liquid in a container and/or for measuring the pumping rate of a chemical injection pump.

Design problems in current systems used for connecting a gauge device to a chemical tank or the like present several disadvantages that are overcome by the present invention.

Current gauge devices utilize a pipe fitting having opposite threaded ends to fluidly connect the gauge to a chemical tank. A cap must be threaded onto one end of the pipe fitting in order to prevent chemicals or fluid from flowing out the end of the fitting that is not connected to the chemical tank. Much time, effort and labor expense is spent trying to properly thread caps onto pipe fittings in an effort to make leak-proof, reliable connections.

A further problem with current systems is that the threaded end between the pipe fitting and the cap is a potential leak path. Ideally, when threading the cap onto the pipe fitting, internal female threads mate with external male threads to form an impenetrable barrier against fluids. In reality, complete metal-to-metal contact between the male and female threads is extremely difficult to achieve and any minute spaces left in between the threads become leak paths. This is a serious problem faced by the petroleum industry as surface leaks of undiluted chemicals used in hydraulic fracturing result in waste of expensive chemicals and pose great risks to the environment and human health.

Currently, a gauge connector is needed to reduce the number of threaded connection points and leak paths between the gauge device and chemical tank. In order to decrease the labor costs associated with assembling current systems, a gauge connector is needed that provides for a quick and efficient method of connecting a gauge device to a chemical tank by eliminating the time spent threading caps to pipe fittings. Additionally, a gauge connector having fewer leak paths is needed in order to decrease the waste, cost, environmental risks, and human health risks associated with chemical leaks.

In view of the foregoing, it is apparent that a need exists in the art for a gauge connector which overcomes, mitigates or solves the above problems in the art. It is a purpose of this invention to fulfill this and other needs in the art which will become more apparent to the skilled artisan once given the following disclosure.

### OBJECTS AND SUMMARY OF THE INVENTION

It is an object of the present invention to overcome the above described drawbacks associated with current devices. To achieve these and other advantages and in accordance with the purpose of the invention, as embodied and broadly described, the present disclosure describes a gauge connector for connecting a gauge device to a chemical tank or the like.

The gauge connector disclosed herein comprises a novel one-piece connector. By utilizing this one-piece connector, the disclosed device provides a gauge connector having a reduced number of threaded connection points and a reduced number of leak paths. This configuration provides many advantages over current assemblies used to connect a gauge device to a chemical tank.

Unlike existing assemblies used to connect a gauge device to a chemical tank, the disclosed gauge connector does not include a pipe fitting with opposite threaded ends and a cap that must be threaded onto one of the threaded ends at the work site. Additionally, unlike existing assemblies, the disclosed gauge connector includes a first arm and a second arm for easily coupling the connector to a gauge device. The arms can be configured as detachable arms to allow a damaged arm to be removed and replaced, which obviates the need to replace the entire gauge connector due to a damaged arm.

Furthermore, the disclosed gauge connector provides for a quick and easy installation method and saves time and labor costs by reducing the number of threaded connection points between a gauge device and a chemical tank. Eliminating threaded connection points also eliminates leak paths, which thereby reduces the waste resulting from chemical leaks and decreases the environmental and human health risks associated with chemical leaks.

These, together with other objects of the invention, along with various features of novelty that characterize the invention, are pointed out with particularity in the drawings, detailed description, and claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and forma part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a top perspective view of a gauge connector constructed in accordance with the teachings of the present disclosure.

FIG. 2 is a bottom perspective view of the device shown in FIG. 1.

FIG. 3 is a bottom perspective view of the device shown in FIG. 1 connected to a gauge device.

FIG. 4 is a bottom perspective view of the device shown in FIG. 1 connected to a gauge device.

FIG. 5 is front perspective view of the device shown in FIG. 1 connected to a gauge device.

FIG. 6 is a side perspective view of the device shown in FIG. 1 connected to a gauge device.

FIG. 7 is a side perspective view of the device shown in FIG. 1 connected to a gauge device.

FIG. 8 is a rear perspective view of the device shown in FIG. 1 connected to a gauge device.

### DETAILED DESCRIPTION OF ILLUSTRATIVE EMBODIMENTS

The terms “top,” “bottom,” “front,” and “rear” are used in the specification to describe the embodiments of the invention as illustrated in the accompanying Figures. It should be appreciated that in actual use, an embodiment of the invention may be rotated as needed to accomplish the objectives of the invention. As a result of such rotation, the various terms used herein of “top,” “bottom,” “front,” “rear,” and the like may not literally apply to a particular arrangement. Such terms are relative and are used herein to describe the Figures for illustration purposes only and are not intended to limit the embodiments shown to any particular orientation.

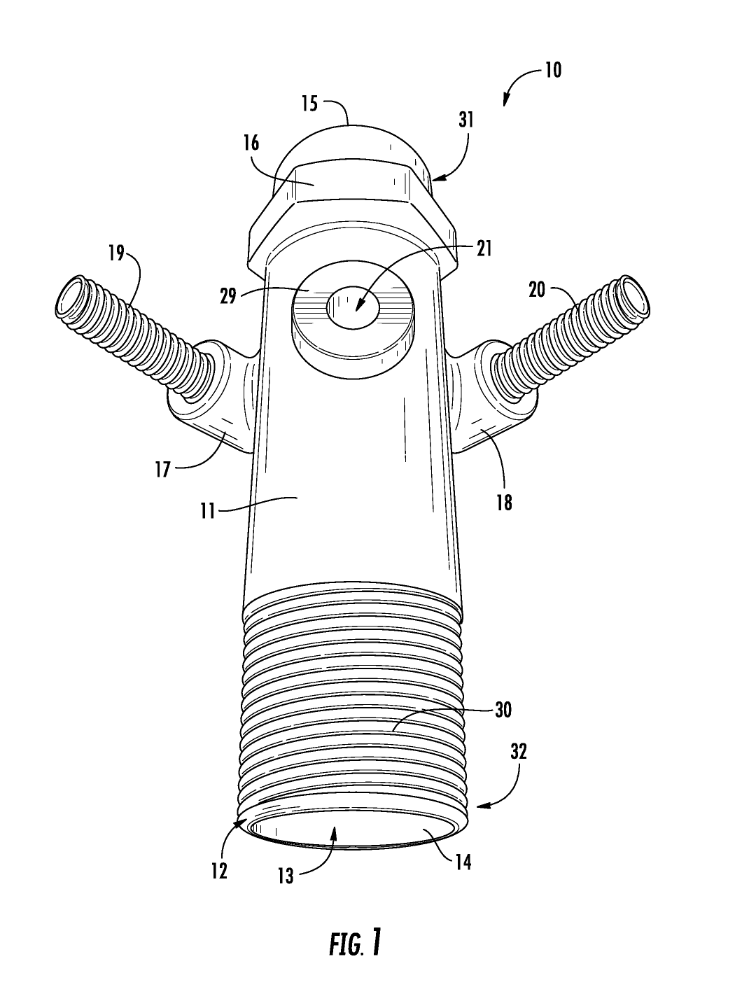

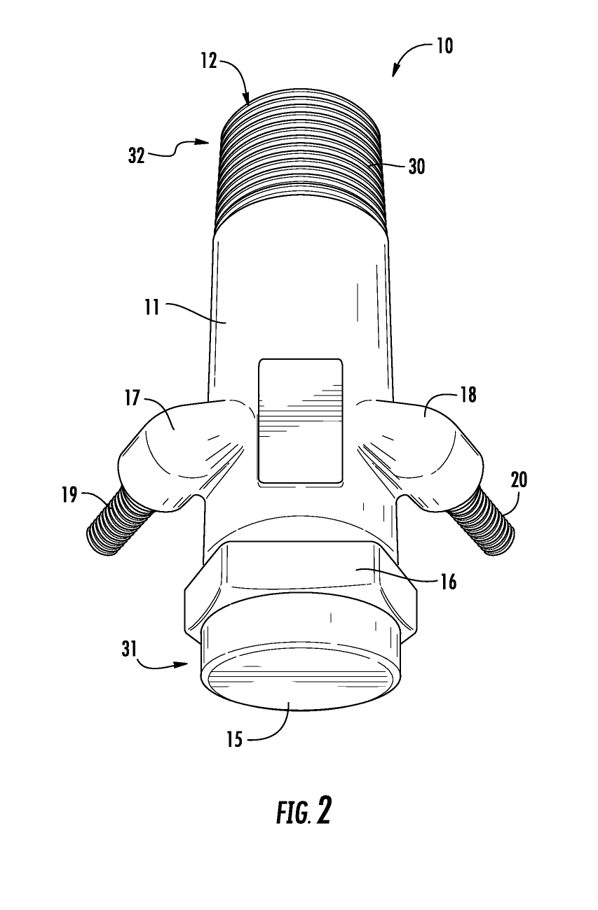

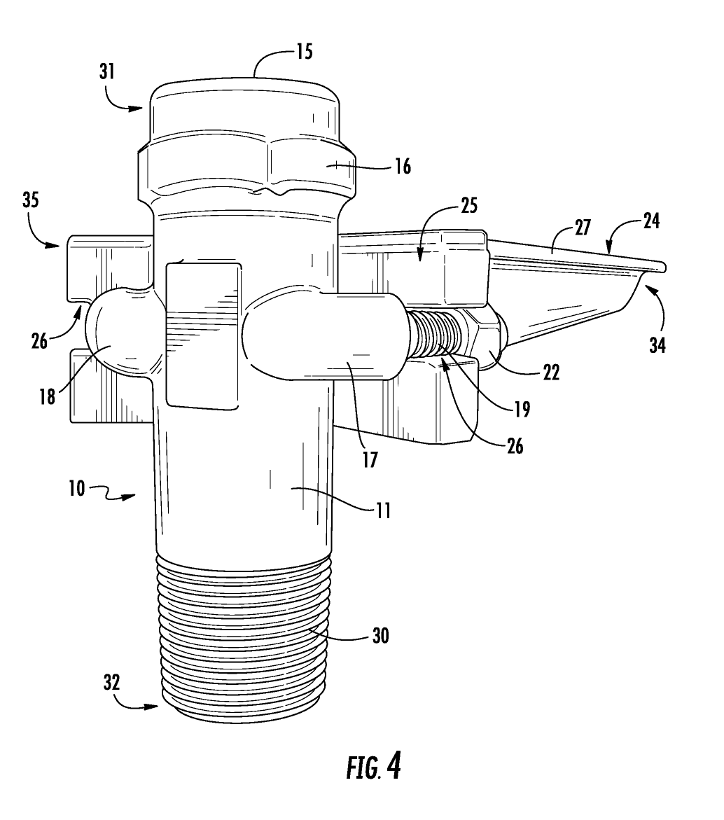

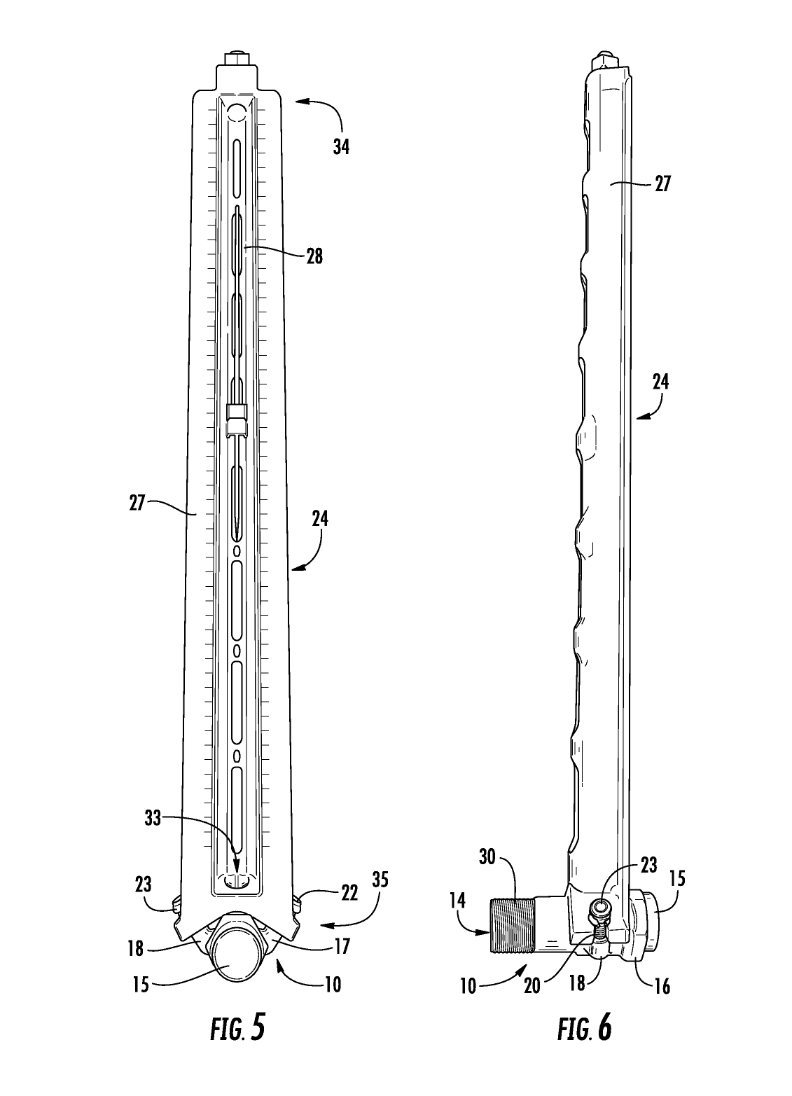

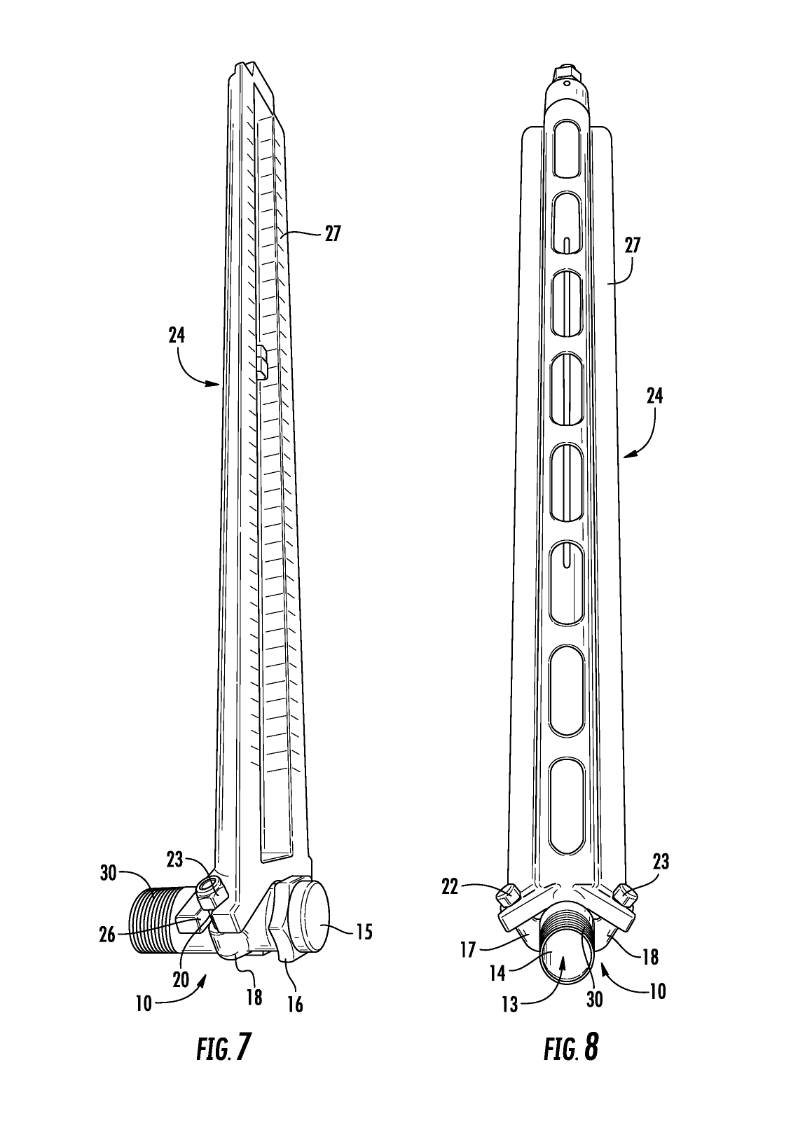

Referring now to FIGS. 1-8, an exemplary embodiment of a gauge connector 10 and a method of use in accordance with the present disclosure are illustrated. In general, the gauge connector 10 is configured to fluidly connect a gauge device 24 to a container that holds liquids, such as a chemical tank (not illustrated).

As illustrated in the accompanying drawings, the gauge connector 10 generally includes a body 11 formed by a cylindrical wall 12 surrounding a fluid passageway 13. The body 11 has a first end 31 and a second end 32. The first end 31 includes a front wall 15 that seals off one end of the fluid passageway 13 formed inside the body 11. As shown in the attached Figures, the first end 31 may further include a hexagonal section 16 which allows a wrench to easily grasp the first end 31 and rotate the gauge connector 10, which is especially useful when attaching and detaching the gauge connector 10 to and from a container, such as a chemical tank.

The second end 32 of the body 11 defines an open end 14 that fluidly connects the fluid passageway 13 of the body 11 with a container, such as a chemical tank. The cylindrical wall 12 of the body 11 surrounding the open second end 32 includes a connection surface 30 for connecting the second end 32 of the body 11 to the container. The connection surface 30 may define a threaded connection surface as shown in the attached Figures.

As shown in FIG. 1, the disclosed gauge connector 10 further includes a gauge connection point 29 formed on the body 11 where the gauge device 24 connects to the body 11 of the gauge connector 10. The gauge connection point 29 includes an aperture 21 formed therethrough for fluidly connecting the fluid passageway 13 of the body 11 with a fluid passageway 33 of the gauge device 24. As will be appreciated by those skilled in the art, the gauge connection point 29 can be configured in a variety of ways in order to connect the fluid passageway 13 of the body 11 with the fluid passageway 33 of the gauge device 24. In the embodiment depicted in the attached drawings, the gauge connection point 29 defines an annular projecting member with an aperture 21 formed therethrough that fluidly connects the fluid passageway 13 of the body 11 with the fluid passageway 33 of the gauge device 24.

The disclosed gauge connector 10 further includes a first shoulder 17 connected to the cylindrical wall 12 of the body 11, and a second shoulder 18 connected to the cylindrical wall 12 of the body 11. The first shoulder 17 is configured to receive a first arm 19 and the second shoulder 18 is configured to receive a second arm 20. The shoulders 17 and 18 may each include an aperture formed through the center of each shoulder 17 and 18 for receiving an arm 19 and 20, as shown in the illustrated embodiment. As depicted in the attached drawings, the first shoulder 17 and the second shoulder 18 may define bosses extending from the cylindrical wall 12 forming the body 11. The shoulders 17 and 18 may include threaded apertures to receive threaded arms 19 and 20 as described below.

As shown in the accompanying drawings, the disclosed gauge connector 10 further includes a first arm 19 connected to the first shoulder 17 and a second arm 20 connected to the second shoulder 18. In one embodiment, the arms 19 and 20 are configured so that they can be removably attached to the shoulders 17 and 18. In other words, the arms 19 and 20 can be configured as detachable arms. For example, as mentioned above, the first shoulder 17 and the second shoulder 18 can include a threaded aperture therethrough and the arms 19 and 20 can be configured as threaded studs so that the arms can be attached to and detached from the shoulders. This configuration allows a user to remove and replace a damaged arm, rather than replacing the entire gauge connector 10 due to a damaged arm. In other embodiments, the arms 19 and 20 may be permanently attached to the gauge connector 10. The arms 19 and 20 are configured to couple the gauge connector 10 to the gauge device 24.

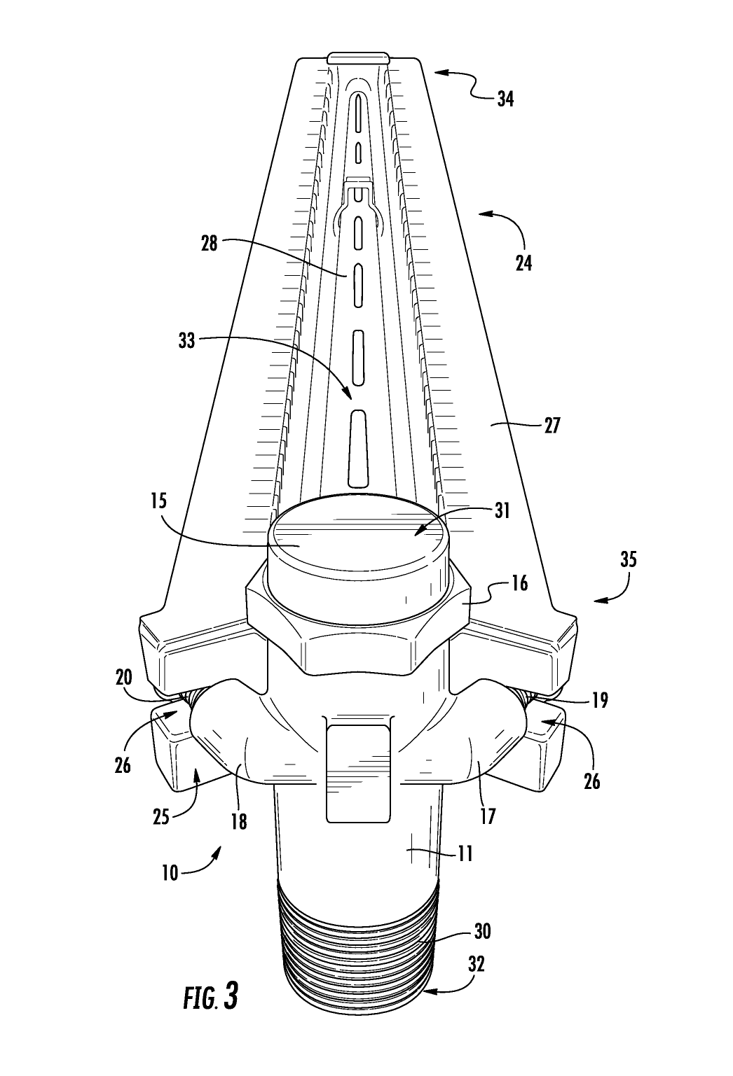

Turning to FIGS. 3-8, the gauge device 24 includes a first end 34 and a second end 35. Additionally, the gauge device 24 includes a tube 28 with a fluid passageway 33 that extends from the first end 34 to the second end 35 of the gauge device 24, and a frame member 27 that surrounds and protects the tube 28. The disclosed gauge connector 10 is configured to be attached to the second end 35 of the gauge device 24. The second end 35 of the gauge device 24 includes a bottom surface 25. When the disclosed gauge connector 10 is connected to the gauge device 24, the gauge connector 10 is disposed adjacent to the bottom surface 25 of the gauge device 24. The second end 35 and the bottom surface 25 of the gauge device 24 include arm receiving members 26 therein. The arms 19 and 20 of the gauge connector 10 are received by the arm receiving members 26 formed in the bottom surface 25 of the gauge device 24. The arm receiving members 26 may be defined as U-shaped cutouts or slots formed in the bottom surface 25 of the gauge device 24. In alternative embodiments, the arm receiving members 26 may be arranged and configured in various ways in order to receive the arms 19 and 20 of the gauge connector 10, as will be obvious to those skilled in the art. The arms 19 and 20 may further include fasteners 22 and 23 that securely hold the arms 19 and 20 in place in the arm receiving members 26 of the gauge device 24. As shown in the attached drawings, each fastener 22 and 23 may simply define a nut threaded onto the end of each arm 19 and 20.

When the arms 19 and 20 of the gauge connector 10 are received by the arm receiving members 26 of the gauge device 24, the gauge connection point 29 of the disclosed gauge connector 10 is arranged and configured to align with a hole formed in the bottom surface 25 of the gauge device 24 in order to fluidly connect the fluid passageway 33 of the tube 28 of the gauge device 24 with the fluid passageway 13 of the gauge connector 10. An O-ring seal (not depicted) may be disposed between the gauge connection point 29 and the hole formed in the bottom surface 25 of the gauge device 24 in order to prevent leakage between the gauge connector 10 and the gauge device 24.

In one of the embodiments contemplated by the present disclosure, the disclosed gauge connector 10 is made of stainless steel. In other embodiments, the gauge connector 10 may be made of steel or polyvinyl chloride (“PVC”) plastic. In still other embodiments, the gauge connector 10 may be made of other suitable materials and may be provided in various sizes suitable for connecting a gauge device 24 to a container that holds liquids, as disclosed herein.

It is important to note that the construction and arrangement of the elements of the gauge connector provided herein are illustrative only. Although only a few exemplary embodiments of the present invention have been described in detail in this disclosure, those skilled in the art who review this disclosure will readily appreciate that many modifications are possible in these embodiments (such as variations in sizes, structures, shapes, orientation of the components of the assembly, and proportions of the various components, etc.) without materially departing from the novel teachings and advantages of the invention.

Though the disclosed gauge connector is illustrated in the accompanying figures and described with its application for use with chemical tanks in the petroleum industry, note that it is not intended to limit the spirit and scope of the present invention solely for use with chemical tanks in the petroleum industry. As will be appreciated by those skilled in the art, the disclosed device may be utilized in a wide range of applications and in various industries.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other uses, features, modifications and variations are, therefore, considered to be a part of this invention, the scope of which is to be determined by the following claims.

1. (canceled)

2. A gauge connector for connecting a gauge device to a container that holds liquids, said gauge connector comprising:
a body formed by a cylindrical wall surrounding a fluid passageway, said body having a first end and a second end, said second end being an open end that fluidly connects said fluid passageway with said container;
a gauge connection point formed on said body where said gauge device connects to said body, said gauge connection point having an aperture formed therethrough for fluidly connecting said fluid passageway of said body with a fluid passageway of said gauge device;
a first shoulder having a first end and a second end, said first end being fixed to said cylindrical wall of said body and said second end being detached from said cylindrical wall of said body, wherein said second end includes an aperture therethrough for receiving an arm;
a second shoulder having a first end and a second end, said first end being fixed to said cylindrical wall of said body and said second end being detached from said cylindrical wall of said body, wherein said second end includes an aperture therethrough for receiving an arm;
a first arm having a first end and a second end, said first end of said first arm being arranged and configured to detachably connect to said second end of said first shoulder and said second end of said first arm being arranged and configured to detachably connect said gauge connector to said gauge device; and
a second arm having a first end and a second end, said first end of said second arm being arranged and configured to detachably connect to said second end of said second shoulder and said second end of said second arm being arranged and configured to detachably connect said gauge connector to said gauge device.

3. (canceled)

4. The gauge connector according to claim 2, wherein said first end of said body further includes a hexagonal section configured to be grasp by a wrench.

5. (canceled)

6. (canceled)

7. The gauge connector according to claim 2, wherein said gauge connection point defines an annular projecting member with an aperture formed therethrough that fluidly connects said fluid passageway of said body with a fluid passageway of said gauge device.

8. (canceled)

9. The gauge connector according to claim 2, wherein said aperture formed through said first shoulder is threaded for receiving said first arm, said first arm being defined as a threaded stud, and said aperture formed through said second shoulder is threaded for receiving said second arm, said second arm being defined as a threaded stud.

10. The gauge connector according to claim 2, wherein said first shoulder defines a first boss extending from said cylindrical wall forming said body, and said second shoulder defines a second boss extending from said cylindrical wall forming said body.

11. (canceled)

12. (canceled)

13. The gauge connector according to claim 2, wherein said gauge device comprises a tube with a fluid passageway, a frame member surrounding said tube, and a bottom surface including one or more arm receiving members formed in said bottom surface.

14. The gauge connector according to claim 13, wherein said first arm and said second arm of said gauge connector are received by said one or more arm receiving members of said gauge device.

15. The gauge connector according to claim 14, wherein said one or more arm receiving members are defined as slots formed in the bottom surface of said gauge device.

16. The gauge connector according to claim 14, further including fasteners that hold said first arm and said second arm in place in said one or more arm receiving members.

17. (canceled)

18. The gauge connector according to claim 14, wherein said gauge connection point is arranged and configured to align with a hole formed in said bottom surface of said gauge device and fluidly connects a fluid passageway of said tube with said fluid passageway of said gauge connector.

19. The gauge connector according to claim 2, wherein said first shoulder and said second shoulder are attached to said body in a manner in which said shoulders form an angle that is greater than 90 degrees and less than 180 degrees.

20. The gauge connector according to claim 2, wherein said first end of said body includes a front wall configured to seal off said fluid passageway.

21. A gauge connector for connecting a gauge device to a container that holds liquids, said gauge connector comprising:
a body formed by a cylindrical wall surrounding a fluid passageway, said body having a first end and a second end, said second end being an open end that fluidly connects said fluid passageway with said container;
a first shoulder having a first end and a second end, said first end being fixed to said cylindrical wall of said body and said second end being detached from said cylindrical wall of said body, wherein said second end includes an aperture therethrough for receiving an arm;
a second shoulder having a first end and a second end, said first end being fixed to said cylindrical wall of said body and said second end being detached from said cylindrical wall of said body, wherein said second end includes an aperture therethrough for receiving an arm;
a first arm having a first end and a second end, said first end of said first arm being arranged and configured to detachably connect to said second end of said first shoulder and said second end of said first arm being arranged and configured to detachably connect said gauge connector to said gauge device; and
a second arm having a first end and a second end, said first end of said second arm being arranged and configured to detachably connect to said second end of said second shoulder and said second end of said second arm being arranged and configured to detachably connect said gauge connector to said gauge device.
